(19) United States
(12) Patent Application Publication
(10) Pub. No.: US 2026/0128390 A1
(43) Pub. Date: May 7, 2026

(54) Energy Storage Cell, Energy Storage Device, Motor Vehicle, and Method for Producing an Energy Storage Cell

(71) Applicant: Bayerische Motoren Werke Aktiengesellschaft, Muenchen (DE)

(72) Inventors: Alexander ADAM, Muenchen (DE); Nina ZENSEN, Pfaffenhofen an der Ilm (DE)

(21) Appl. No.: 19/116,441

(22) PCT Filed: Sep. 6, 2023
(86) PCT No.: PCT/EP2023/074456

§ 371 Date: Mar. 28, 2025

(30) Foreign Application Priority Data
Sep. 29, 2022 (DE) 10 2022 125 203.5

(51) Int. Cl. H01M 10/42; B60L 50/64; H01M 10/04; H01M 50/103; H01M 50/107; H01M 50/44; H01M 50/474

(52) U.S. Cl. CPC H01M 10/4235; B60L 50/64; H01M 10/049; H01M 50/103; H01M 50/107; H01M 50/44; H01M 50/474; H01M 2220/20

(57) ABSTRACT

Energy storage cells are provided herein, the energy storage cells including a cell housing defining an inner region; an electrode assembly disposed in the inner region together with an electrolyte; and a support element disposed between a surface of the energy storage cell and at least one part of the electrode assembly, the support element contacting the surface and the at least one part; wherein the support element has a carrier part, and fill material held by the carrier part; and wherein the support element is configured to at least partially release the fill material to the electrolyte and to decrease in size in a direction transverse to the surface. Energy storage devices including the energy storage cells are further provided. Motor vehicles including the energy storage cells or energy storage devices are further provided. Methods for producing the energy storage cells are further provided.

### BACKGROUND AND SUMMARY

The present disclosure relates to an energy storage cell, to an energy store comprising the energy storage cell, to a motor vehicle comprising the energy storage cell or the energy store, and to a method for producing the energy storage cell.

Modern energy storage cells for motor vehicle traction batteries, for example rechargeable lithium-ion batteries (also referred to as secondary lithium-ion batteries in the literature), generally have an electrode assembly which comprises an anode, a cathode, and, disposed between the cathode and the anode, a separator and which is disposed together with an electrolyte in a cell housing of the energy storage cell. The anode and the cathode each comprise an electrode which is usually metallic (copper, for example, on the anode side; aluminum, for example, on the cathode side) and which is coated with an active material (graphite, for example, on the anode side; lithium cobalt oxide or lithium manganese oxide, for example, on the cathode side). The cell housing, also referred to as a can in the case of cylindrical energy storage cells, may be coated with an insulator on the outside. The separator is intended to be ion-conductive (in particular, pervious to lithium ions), but otherwise electrically insulates the anode from the cathode.

Over the lifetime of such energy storage cells, the electrode assembly, in particular the active material on the anode side, can swell with each charge cycle. The size of the cell housing of the energy storage cell is therefore commonly chosen such that space is available for swelling of the electrode assembly. By contrast, the less space occupied by the electrode assembly in the cell housing (in other words, the lower the packing ratio of the energy storage cell), the more likely that deposition of lithium metal as sponge or dendrites (so-called lithium plating) may occur in the electrode assembly. To minimize lithium deposition, it is known from the art to subject the positive and/or negative electrode of a lithium cell to a corona treatment. In relation to this, document DE 10 2014 218 143A1, for example, discloses a method for producing a lithium cell, in which a particulate active material and a coating composition containing a binder are applied to a metal foil in order to form a positive/negative electrode. Thereafter, the positive/negative electrode is compressed. The separator is introduced between the electrodes, followed by filling a cell housing with a liquid electrolyte. Prior to wetting with the liquid electrolyte, the positive and/or negative electrode is subjected to corona treatment so that the liquid electrolyte will penetrate into the pores of the electrode.

Against this background, it is an object of the present disclosure to provide an energy storage cell which has a long lifetime and can store energy reliably. It is a further object of the present disclosure to provide a corresponding energy store, a corresponding motor vehicle, and a corresponding method for producing an energy storage cell.

This object is achieved by an energy storage cell according to the present disclosure, an energy store having the features provided in the present disclosure, a motor vehicle according to the present disclosure, and a method for producing an energy storage cell having the features provided in the present disclosure.

The energy storage cell is preferably intended for a vehicle traction battery, for example a rechargeable lithium-ion battery (so-called secondary lithium-ion battery), and comprises a cell housing which defines an inner region of the energy storage cell, an electrode assembly which is disposed in the inner region together with an electrolyte, and a support element which is disposed between a surface of the energy storage cell and at least one part of the electrode assembly and which contacts the surface and the part of the electrode assembly. The support element has a carrier part and fill material held by the carrier part (at least temporarily, in particular in an initial state of the support element). Furthermore, the support element is configured to at least partially release the fill material to the electrolyte and, as a result, to decrease in size in a direction transverse to the surface, in other words, to shrink in a particular direction. The particular direction is preferably a radial direction of the energy storage cell.

In other words, the support element can degrade and, in doing so, release a portion of the mass of the support element (or reduce the volume of the support element) to free space in the inner region of the cell housing for the electrode assembly, the electrode assembly being able to expand into said space under operating conditions. The swelling of the electrode assembly can therefore be compensated for. Accordingly, the energy storage cell can be produced with an initially relatively large effective packing ratio of support element and electrode assembly in relation to the entire inner volume of the cell housing, in other words, the inner region can already be largely filled up when the energy storage cell is produced.

Consequently, the electrode assembly can be accommodated in the cell housing such that an anode, a separator, and a cathode of the electrode assembly are in contact with one another over a comparatively large surface area. A reduction of the risk of lithium plating and an extension of the lifetime of the energy storage cell can therefore be synergistically achieved. A constant contact pressure can assist in conducting the gas out of the electrode assembly (in other words, ensuring that as few gas bubbles as possible remain between the electrodes). Because the support element is designed to shrink in the aforementioned direction, the support element effectively gives way, such that the cell housing can be under less outward tension (can “swell up” less) over the lifetime of the cell housing, even with a swelling electrode assembly. Therefore, the energy storage cell can maintain the outer dimensions of the energy storage cell for an advantageously longer period of time, thus allowing better and longer-term accommodation thereof in an energy storage cell module housing or in an energy store housing.

The electrode assembly preferably comprises an anode, a cathode, and, disposed between the anode and the cathode, a (one-part or multipart) separator. The anode/cathode preferably comprises a metallic electrode (copper, for example, on the anode side; aluminum, for example, on the cathode side) coated with an active material. Advantageously, a material of the anode of the electrode assembly contains silicon, in particular silicon oxide or a silicon-carbon composite, allowing an effective increase in the energy density of the energy storage cell. The electrode assembly may be in wound form (as a so-called jelly roll) or in stacked form (for example, as a so-called Z-stack). Especially in the latter case, but not only in the latter case, the anode, the cathode, and/or the separator may preferably each be in multiple parts.

The support element is preferably not part of the electrode assembly. In particular, the support element may be neither an electrode nor a separator of the electrode assembly. Rather, the support element is preferably a separate component which, in particular, may be separate from the electrode assembly and/or the cell housing. The support element, in an initial state in which the fill material is part of the support element and thus held on the carrier part, may make no contribution to electrochemical reactions in the energy storage cell, in other words, may be electrochemically passive.

In the context of the present disclosure, the term “fill material” generally refers to a material (in other words, a chemical substance, in particular a pure substance or a mixture) with which a portion of the support element is at least partially filled. The fill material may in principle be in any desired phase. Preferably, the fill material is solid (in particular pulverulent) or liquid. In the context of the present disclosure, the word “fill material” (unless otherwise indicated) means the entire fill material of the support element. The fill material may contain multiple portions, each of which is in the form of a specific chemical substance.

The support element is preferably fitted interlockingly and/or frictionally in the energy storage cell between the aforementioned part of the electrode assembly and the surface of the energy storage cell. If the support element is fitted interlockingly, there is by definition (substantially) no normal force able to act in the aforementioned direction between the support element and the surface of the energy storage cell. The frictional variant by contrast requires that the support element be clamped between (and thus by) the surface of the energy storage cell and the at least one part of the electrode assembly. In this latter variant, the normal force between the support element and the electrode assembly is therefore required. The force may be homogeneously distributed across the contact surfaces.

The load path here runs from the surface of the energy storage cell across the support element and then across a boundary between the support element and the electrode assembly to a further surface of the energy storage cell that is opposite the surface of the energy storage cell contacting the support element, said further surface being preferably likewise a wall of the cell housing. In other words, the electrode assembly is supported on the further surface, is (slightly) preloaded, and presses the (likewise slightly preloaded) support element against the surface of the energy storage cell contacting the support element. In the initial state, the support element may have a thickness of 0.5 mm to 3 mm in the direction R.

In order to be able to realize the aforementioned fitting situation in an advantageously reproducible manner, the cell housing is preferably rigid (solid). Accordingly, the energy storage cell is preferably in the form of a prismatic cell or cylindrical cell. Preferably, the energy storage cell is thus in particular not a pouch cell. The surface of the energy storage cell contacted by the support element may preferably be in planar contact with a side of the support element that is opposite the part of the electrode assembly. The surface of the energy storage cell contacting the support element may be an inner face of the cell housing, in particular an inner surface of the cell housing wall of the energy storage cell.

When the support element is viewed in the aforementioned direction, a contour of the support element may correspond to the contour of the electrode assembly. If the energy storage cell is in the form of a prismatic cell, the cell housing wall may be preferably a longitudinal wall of the cell housing (in other words, the cell housing wall with the greatest dimension (length)). In other words, the electrode assembly in this case may be supported on the longitudinal wall of the cell housing via the support element. Accordingly, a first contact area between the support element, in particular the carrier part, and the inner face in this case is preferably substantially level (plane). On a second side of the support element which is opposite the first contact area and is facing the electrode assembly, a second contact area between the support element and the electrode assembly is preferably likewise substantially level. The configuration of said second contact area is preferably defined by the surface geometry of an end face of the electrode assembly that is facing the support element; said end face is preferably stiffer than the support element on the second contact area.

If, by contrast, the energy storage cell is a cylindrical cell, the inner face is preferably the (entire) inner circumferential face of the cell housing. The support element in this variant is preferably substantially in the form of a hollow-cylindrical body. The (wound) electrode assembly here may be disposed in the interior of the hollow-cylindrical body at least sectionally. An outer circumferential face of the electrode assembly is therefore in contact with an inner circumferential face of the hollow-cylindrical body. Accordingly, the outer circumferential face of the support element may be supported on an inner circumferential face of the cell housing, and the support element may tension (compress) the electrode assembly radially inward by an inner circumferential face thereof. Advantageously, the anode, the cathode, and the separator are therefore pressed together.

Alternatively, the surface of the energy storage cell contacted by the support element may be a surface of the separator of the electrode assembly. In this case, the support element is preferably provided, in particular clamped, between a first section and a second section of the electrode assembly. The aforementioned part of the electrode assembly in this variant may therefore be the second section of the electrode assembly. A surface of the first section of the electrode assembly that is facing away from the support element and a surface of the second section of the electrode assembly that is facing away from the support element are preferably in (direct) contact with the wall of the cell housing. In this alternative, the energy storage cell may be cylindrical or prismatic.

Preferably, the fill material is encapsulated or enveloped on or in the support element. The support element may in particular be in the form of a capsule (at least partially) filled with at least one portion of the fill material. This means that the carrier part may have at least one shell which delimits an interior (in each case), the fill material being at least partially contained in the interior. The interior may in turn be divided into multiple separate (in other words, non-interconnected) chambers, in particular a first chamber, a second chamber, and/or a third chamber. A partition or partitions between adjacent chambers may be made of the same material as the shell. Each of the partitions may be in the form of a membrane (so-called burst diaphragm). Advantageously, main faces of the chambers extend substantially parallel to the surface of the energy storage cell contacting the support element. The fill material may be at least partially contained in the first chamber, the second chamber, and/or the third chamber. In other words, a first portion of the fill material may be contained in the first chamber, a second portion of the fill material in the second chamber, and/or a third portion of the fill material in the third chamber.

The shell is preferably in the form of a membrane (film). The membrane may be pervious to the fill material; however, it is preferably impervious to the fill material. Preferably, the membrane is flexibly, in particular elastically, deformable. The support element is therefore able to decrease in size in the aforementioned direction transverse to the surface as a result of expansion of the energy storage cell, and, at the same time, stretch in a different direction. In the former case, the fill material can be at least partially released to the electrolyte through the at least one shell. The support element here can be squeezed almost like a sponge. This functionality can also be realized by the carrier part being porous at least sectionally. The fill material can therefore be at least partially intercalated in pores of the carrier part. The carrier part is preferably a porous matrix, in particular a polymer matrix. The carrier part, in particular the base section of the carrier part or the polymer matrix, may be made of a polymer. The polymer may comprise or be, for example, polyethylene terephthalate (PET), polypropylene (PP), polyethylene (PE), polytetrafluoroethylene (PTFE), polyvinylidene fluoride (PVDF), and/or polyetheretherketone (PEEK).

In the second abovementioned case, the stretching of the shell in the different direction can result in (preferably irreversible) opening of the shell, in particular stretching thereof beyond the yield point thereof and thus tearing thereof (in other words, crushing thereof between the aforementioned surface of the energy storage cell and the electrode assembly). Consequently, the fill material originally held on the carrier part can escape from the interior and be released to the electrolyte. The electrolyte can therefore (even long after the energy storage cell was formed) be supplied with useful fill material, which will be described in more detail hereinafter. At the same time, the support element can advantageously synergistically decrease in size in the aforementioned direction transverse to the surface so that the energy storage cell has less of a tendency to inflate.

If the support element comprises the first and second chambers, the carrier part may be designed to open the first chamber toward the immediate vicinity of the support element at a lower pressure, exerted on the support element by the part of the electrode assembly, than the second chamber. In other words, the first chamber can open on exceeding of a first pressure threshold for a pressure at which the support element is clamped between the surface of the energy storage cell and the part of the electrode assembly, without the second chamber being opened, which can lead to a temporary reduction of the tension in the support element. As a result of further expansion of the electrode assembly, the compressive force (tension) acting on the support element can increase again as the energy storage cell is further operated. The second chamber can then open after a second pressure threshold higher than the first pressure threshold is exceeded. If the support element also comprises the third chamber, the third chamber can (analogously as a result of further expansion of the electrode assembly) open once a third pressure threshold greater than the first pressure threshold and/or the second pressure threshold is exceeded.

In one variant, the carrier part may be fiber-reinforced. The carrier part may furthermore be in the form of a textile, in particular in the form of a woven textile or in the form of a nonwoven textile, at least sectionally. Preferably, the carrier part comprises a plurality of the aforementioned shells, each shell with the portion of the fill material contained therein forming a capsule. These capsules may be intercalated in the textile between fibers of the textile and thus be held by the textile. Alternatively, the capsules/shells may be integrally joined to one another and optionally to a base section of the carrier part. The base section may be rigid to stiffen the support element. Accordingly, the base section may be a rigid plate in the case of the prismatic cell and a rigid hollow cylinder in the case of the cylindrical cell. The plate may be disposed on a side of the shells/capsules that is facing the aforementioned surface of the energy storage cell contacting the support element.

The capsules may have the above-described features of the chambers and thus form chambers within the meaning of the above description. The capsules may be in the form of bubbles, which means that the carrier part may comprise multiple first shells, multiple second shells, and/or multiple third shells in which the first portion of the fill material, the second portion of the fill material, and the third portion of the fill material are respectively contained. Each of the shells, together with the portion of the fill material enveloped by the shell, forms a corresponding (first/second/third) capsule. Preferably, the first capsules are (in terms of volume, in particular in terms of the inner diameter thereof) larger than the second capsules, and/or smaller than the third capsules. Most preferably, all first capsules are disposed according to a first grid at regular first distances from one another. The same may apply to the second and third capsules, which are therefore disposed according to a second grid and third grid, respectively, at regular second distances and third distances, respectively. This disposal may also be realized by the above-described fiber-reinforced variant of the carrier part. Preferably, the first portion of the fill material and the second portion of the fill material differ from one another. If the third portion of the fill material is present, said third portion of the fill material may likewise differ from the first portion of the fill material and/or from the second portion of the fill material.

The (entire) fill material is preferably at least partially soluble in the electrolyte. Most preferably, the fill material, in particular the first portion of the fill material, the second portion of the fill material, and/or the third portion of the fill material, comprises a (liquid or solid) electrolyte additive (for the anode and/or the cathode), a lithium supporting electrolyte, a scavenger, and/or a reaction suppressor. The electrolyte additive may contain one or more of the following substances: fluoroethylene carbonate (FEC), vinylene carbonate (VC), dimethylvinylene carbonate-OCF₃ (DMVC-OCF3), allylethyl carbonate (AEC), tetrachloroethylene (TCE), 2-vinylpyridine (VP), butylene sulfite (BS), 1,3-propane sultone (PS). Further suitable electrolyte additives are ionic additives, isocyanate-based additives, borates, and/or boroxines. The lithium supporting electrolyte may comprise one or more of the following substances: LiPF₆, LiBF₄, LiTFSi, lithium bis(oxalato)borate (LiBOB), LiMOB, LiF. Furthermore, the lithium supporting electrolyte may comprise: phosphates, borates, imides, heterocyclic anions, and/or aluminates.

The scavenger may, by definition, be a chemical substance which is added to a mixture in order to remove or deactivate contaminants and undesirable reaction products such as oxygen to ensure that the contaminants and undesirable reaction products do not undergo any undesirable reactions. The scavenger or the reaction suppressor may contain a HF scavenger (for example, DMVC-OTMS). For protection against overcharging (at the cathode/anode), the fill material, or the first, second, and/or third portion of the fill material, may contain one or more of the following substances: phenothiazine, TEMPO, artificial interface, polyacrylic acid (PAA), polyvinyl alcohol (PVA). The substances can extend the lifetime of the energy storage cell.

An energy store proposed herein is intended for installation in a motor vehicle. The (motor vehicle) energy store may in particular be a traction battery for the motor vehicle. The energy store comprises at least one, preferably a plurality of, energy storage cell(s) that have been described in detail above. The energy storage cells are preferably accommodated side-by-side in the store housing such that the support elements thereof are aligned substantially parallel to one another, which can allow long-term residence of the energy storage cells in the store housing. The energy store may furthermore comprise multiple structurally separated storage modules, each of which contains a set of a plurality of the energy storage cells. At the same time, each storage module may be surrounded by a module housing.

The motor vehicle proposed herein may in particular be an aircraft, watercraft, or land vehicle. Preferably, the motor vehicle is an automobile or a utility vehicle. The motor vehicle comprises the energy store that has been described above. Preferably, the energy store is in the form of a flat store. It may in particular be disposed between two adjacent axles (in particular a front axle and a rear axle) of the motor vehicle in the underfloor area of the motor vehicle.

The method proposed herein is intended for producing an energy storage cell, in particular the energy storage cell that has been described in detail above, and comprises the following steps, which are preferably carried out in the order below: providing the cell housing; disposing, in particular inserting, the electrode assembly into the inner region of the energy storage cell; disposing, in particular inserting, the support element between the surface of the energy storage cell and the at least one part of the electrode assembly such that the support element is in contact with the surface and the part of the electrode assembly; and forming the energy storage cell.

Furthermore, it is conceivable to insert the support element into the inner region at the same time as the electrode assembly. Preferably, before the forming, the support element is substantially interlockingly accommodated between the aforementioned surface and the part of the electrode assembly. Most preferably, during the forming, the support element is clamped between the surface of the energy storage cell and the part of the electrode assembly. Accordingly, after the forming, the support element may be clamped more strongly between the aforementioned surface and the part of the electrode assembly than before the forming.

Any of the features, in particular all the features, that have been described above in connection with the energy storage cell may be realized in the energy store, in the motor vehicle, and in the method of producing the energy storage cell.

Preferred embodiments of an energy storage cell, an energy store, a motor vehicle, and a method for producing an energy storage cell will now be explained in more detail with reference to the accompanying schematic drawings not drawn to scale, where

### BRIEF DESCRIPTION OF THE DRAWINGS

FIG. 1 shows a cross-sectional view of one variant of an energy storage cell, with the support element of the energy storage cell being in the initial state, in which the fill material is completely held on the carrier part;

FIG. 2 shows a detailed view of the energy storage cell from FIG. 1 with the support element in the initial state;

FIG. 3 shows a cross-sectional view of the energy storage cell from FIG. 1, with the support element being in the size-reduced state, following partial release of the fill material to the electrolyte;

FIG. 4 shows a detailed view of the energy storage cell from FIG. 1 with the support element in the size-reduced state according to FIG. 3;

FIG. 5 shows a detailed cross-sectional view of a further variant of an energy storage cell, with the support element of the energy storage cell being in the initial state;

FIG. 6 shows the energy storage cell from FIG. 5 with the support element in the size-reduced state;

FIG. 7 shows a detailed cross-sectional view of a support element having multiple chambers according to a further variant of an energy storage cell, with the support element being in the initial state;

FIG. 8 shows a detailed cross-sectional view of a support element having multiple capsules according to a further variant of an energy storage cell, with the support element being in the initial state;

FIG. 9 shows a detailed cross-sectional view of a support element having multiple capsules held by a woven according to a further variant of an energy storage cell, with the support element being in the initial state;

FIG. 10 shows a detailed cross-sectional view of a further variant of an energy storage cell, with the support element being disposed between two sections of the electrode assembly;

FIG. 11 shows a perspective view of the energy storage cell from FIG. 1;

FIG. 12 shows a perspective view of a further variant of an energy storage cell, with the energy storage cell being in the form of a cylindrical cell;

FIG. 13 shows a sectional view of an energy store comprising multiple energy storage cells according to any of FIGS. 1 to 12;

FIG. 14 shows a motor vehicle comprising the energy store from FIG. 13; and

FIG. 15 shows a method for producing an energy storage cell.

### DETAILED DESCRIPTION OF THE DRAWINGS

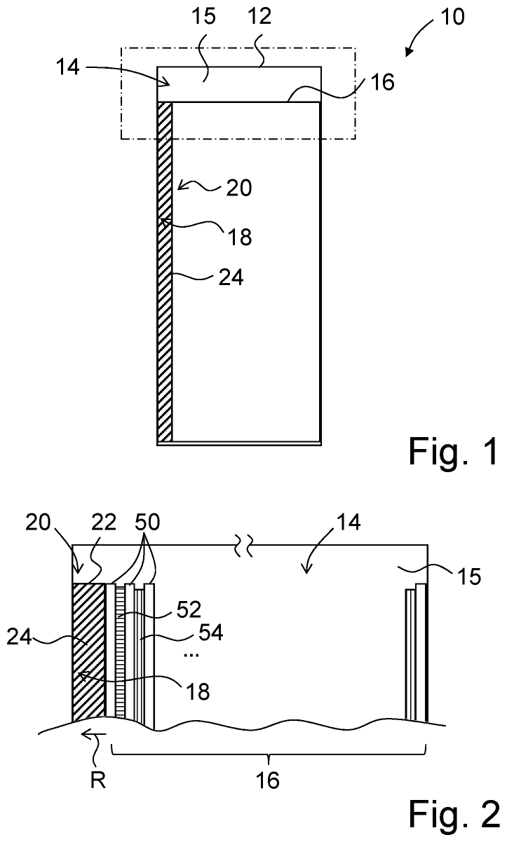

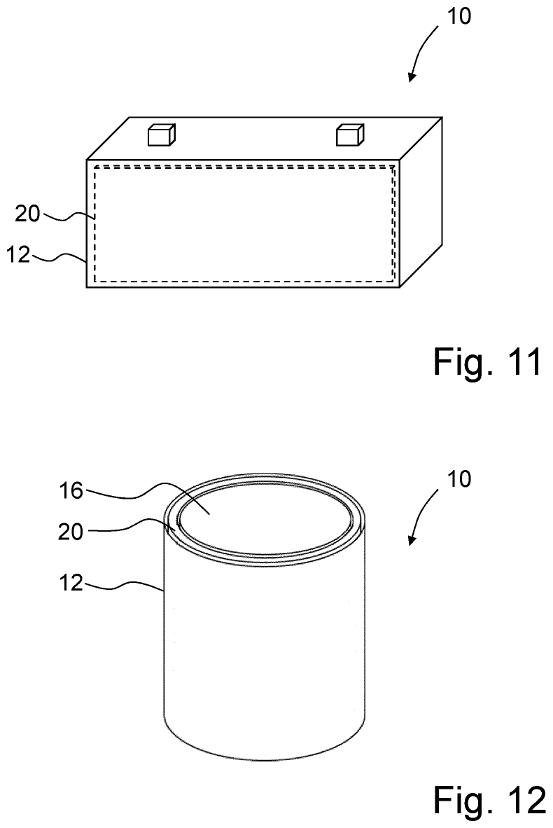

FIGS. 1 to 4 show an energy storage cell 10 intended for installation into an energy store 100 for a motor vehicle 200 (here: automobile) shown in FIG. 14. The energy storage cell 10 here is, by way of example, in the form of a prismatic cell (see FIG. 11) and contains a rigid cell housing 12. The longitudinal sides (longitudinal walls) of the cell housing 12 extend parallel to one another and, in FIGS. 1 to 4, perpendicular to the plane of the page, and so the direction of view from FIGS. 1 to 4 is the longitudinal direction. A main plane (central longitudinal plane) of the prismatic cell extends parallel to said longitudinal sides.

The cell housing 12 delimits an inner region 14 of the energy storage cell 10 and seals the inner region 14 with respect to the environment around the energy storage cell 10 for an electrolyte 15 present in the inner region 14. Together with the electrolyte 15 and with a support element 20 explained in more detail below, an electrode assembly 16 of the energy storage cell 10 is provided in the inner region 14. The electrode assembly 16 here is, by way of example, in stacked form. However, the present disclosure also applies mutatis mutandis to wound electrode assemblies 16. The electrode assembly 16 comprises a multipart separator 50 and also a multipart anode 52 and a multipart cathode 54, there being situated between any one section of the anode 52 and the section of the cathode 54 adjacent thereto a section of the separator 50. The sections of the anode 52, the cathode 54 and the separator 50 are planar and aligned substantially parallel to one another. The separator 50 is accordingly in planar contact with the support element 20. The anode 52 may contain a silicon-carbon composite. Alternatively, the anode 52 may contain graphite.

The support element 20 has a carrier part 22 and, at least in the initial state of the support element 20 shown in FIGS. 1 and 2, fill material 24 held by the carrier part 22. The support element 20 is disposed, in particular clamped, between a surface 18 of the energy storage cell 10 and the electrode assembly 16 and is planar. The surface 18 is an inner surface of one of the longitudinal walls (the left longitudinal wall as viewed in FIGS. 1 to 4). In other words, the support element 20 has a first contact area by which the support element 20 is supported on the surface 18 and presses the electrode assembly 16 against an inner surface of the cell housing 12 opposite the surface 18 (second contact area) so long as the support element 20 is provided with the fill material 24.

The carrier part 22 of the support element 20 is in the present case (in the initial state) a shell, in particular an elastic membrane, which delimits an interior of the carrier part 22. The shell is impervious to the fill material 24 so long as the shell is intact (closed) and the support element 20 is in its initial state. Furthermore, the shell is flexible and can open/tear as a result of the pressure exerted by the electrode assembly 16. In addition, in the variant from FIG. 1, the entire fill material 24 is present in the interior, in other words, surrounded by the shell, so long as the support element 20 is in the initial state; in the other variants described below, multiple shells may jointly form the carrier part 22 of the support element 20 and each encase a portion of the fill material 24.

If, under operating conditions, the electrode assembly 16 expands in a direction R drawn in FIG. 2 and transverse, in particular perpendicular, to the surface 18, the support element 20 can be compressed in the direction R, in other words, the clamping force (pressure) acting on the support element 20 rises. When a predetermined expansion of the electrode assembly 16 in the direction R, or a predetermined pressure threshold at which the support element is compressed in the direction R, is exceeded, the carrier part 22 opens and the fill material 24 is released to the electrolyte 15. This opening is achieved by the support element 20 being stretched perpendicular to the direction R, in other words, along the surface 18. If needed, a subregion of the inner region 14 beyond one end (top end in FIG. 1) of the electrode assembly 16 may be made available for this purpose, as shown in FIG. 1. When the shell opens, a yield point of the shell may be exceeded. Furthermore, both a gradual degradation and a catalyzed degradation (due to temperature/pressure/resultant byproducts during the cyclization of the energy storage cell) are conceivable.

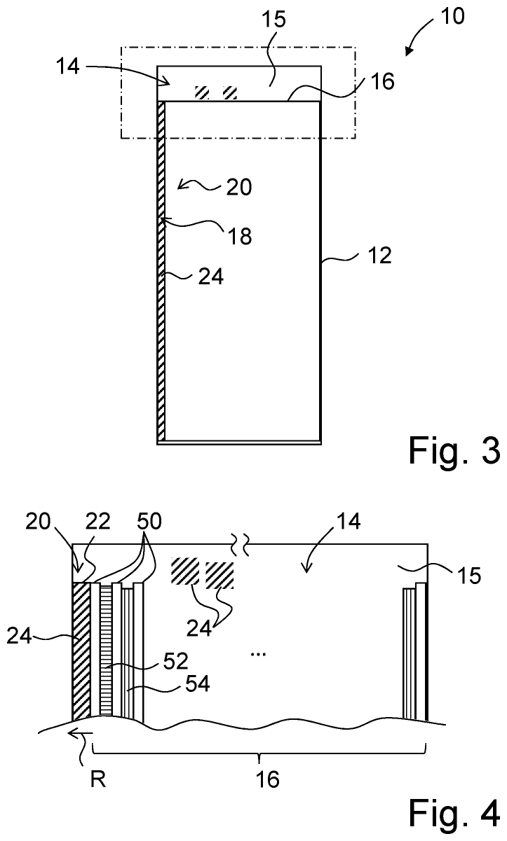

As a result of the release of the fill material 24 to the electrolyte 15, the support element 20 decreases in size in the direction R and thus reaches its size-reduced state shown in FIGS. 3 and 4. The portion of the fill material 24 released to the electrolyte 15, as shown schematically in the figures, may mix with the electrolyte 15 (for example, dissolve in the electrolyte 15) and immediately be available to the electrochemical reactions in the energy storage cell 10. The greater the expansion of the electrode assembly 16 in the direction R, the more of the fill material 24 that is removed from the support element 20. Advantageously, the fill material 24 here is a lithium salt, though it may alternatively comprise a scavenger and/or a reaction suppressor.

In one modification, it is conceivable that the shell does not open and is, instead, permeable (pervious) to the fill material 24. In this case, the fill material 24 may therefore be at least partially pressed (“squeezed”) through the shell, in particular beyond the second contact area, as a result of the expansion of the electrode assembly 16.

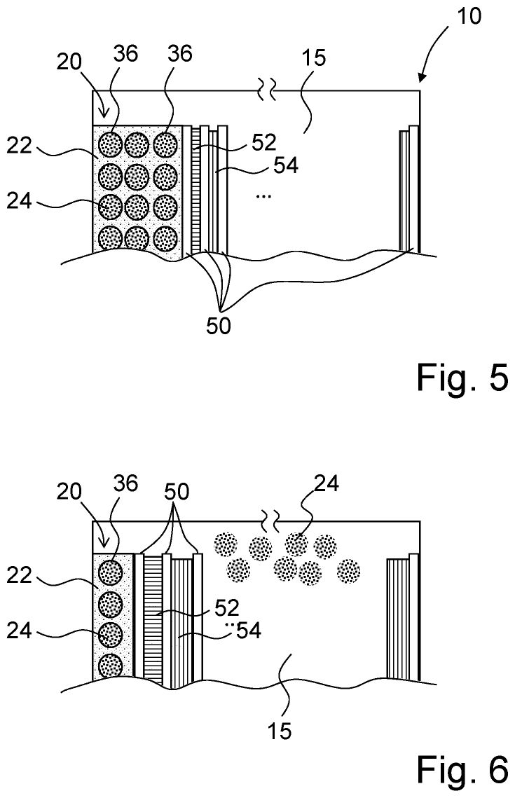

A further energy storage cell 10 from FIGS. 5 and 6 differs from the energy storage cell 10 from FIGS. 1 to 4 in that the carrier part 22 has multiple pores 36 (in other words, is porous). At the same time, the fill material 24 is intercalated in the pores 36 of the carrier part 22. In this configuration, the carrier part 22 is in particular in the form of a polymer matrix (composed of polyethylene terephthalate here). On their inner surfaces, the pores 36 have shells having the above-described features. In FIG. 5, the support element 20 is in the initial state, and in FIG. 6, the support element 20 is in the size-reduced state. When the electrode assembly 16 thus grows in the direction R (compare to FIG. 2), the fill material 24 is gradually pressed out of the pores 36, with tearing of the shells, in order to reach the electrolyte 15. Furthermore, the energy storage cell 10 from FIGS. 5 and 6 has all the features of the energy storage cell 10 from FIGS. 1 to 4.

In the case of further energy storage cells 10, the support elements 20 of which are shown in FIGS. 7 to 9, the (entire) fill material 24 comprises multiple portions. The portions of the fill material 24 are composed of different chemical substances. This means that the fill material 24 may comprise a first portion in the form of a first chemical substance, a second portion in the form of a second chemical substance, and a third portion in the form of a third chemical substance. For example, the first portion of the fill material 24 may comprise a lithium salt. The second portion of the fill material 24 may comprise an electrolyte additive (the same electrolyte additive may also be contained in the electrolyte when the respective support element 20 is in the initial state). The third portion of the fill material 24 may contain a scavenger.

In the variant from FIG. 7, the carrier part 22 (in particular the interior) is divided into at least a first chamber 30, a second chamber 32, and a third chamber 34. The first portion of the fill material 24 is contained in the first chamber 30. The second portion of the fill material 24 is contained in the second chamber 32. The third portion of the fill material 24 is contained in the third chamber 34. The second chamber 32 may open at or above a second pressure threshold which is greater than a first pressure threshold at which the first chamber 30 opens and/or which is lower than a third pressure threshold at which the third chamber 34 opens.

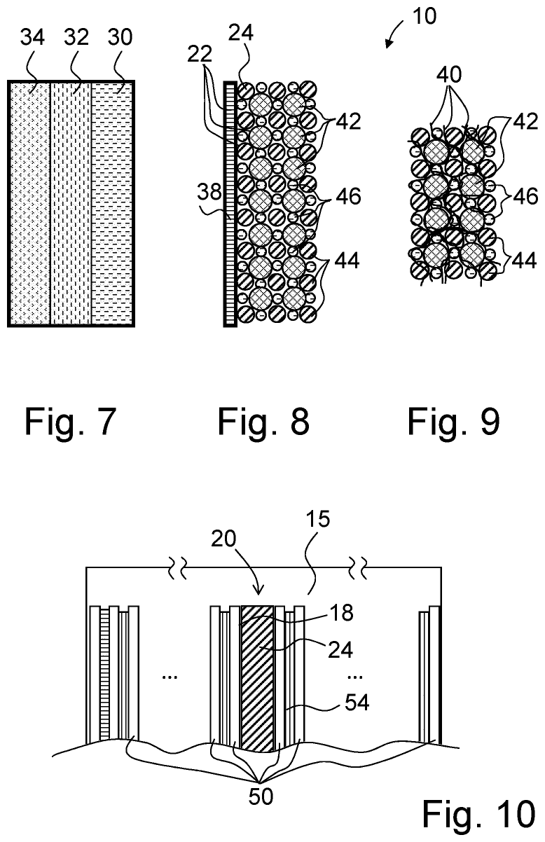

In the variant from FIG. 8, the carrier part 22 comprises a base section 38 in the form of a relatively rigid plate, (preferably integrally) joined to which are multiple capsules over which the fill material 24 is distributed. In this variant, the capsules may comprise first capsules 42, second capsules 44, and third capsules 46. Similarly to the variant from FIG. 7, the first portion of the fill material 24 may be contained in all of the first capsules 42, the second portion of the fill material 24 may be contained in all of the second capsules 44, and/or the third portion of the fill material 24 may be contained in all of the third capsules 46. The second capsules 44 may have a smaller inner volume than the first capsules 42 and/or have a larger inner volume than the third capsules 46.

The variant of the support element 20 from FIG. 9 differs from the support element 20 from FIG. 8 in that the carrier part 22 of the support element 20 from FIG. 9 is fiber-reinforced. The base section 38 here is not in the form of a relatively rigid plate, but in the form of a textile 40 (woven). The fibers of said woven extend among the first, second and/or third capsules 42, 44, 46. This allows stiffening of the support element 20.

Furthermore, the energy storage cells 10 having the support elements 20 according to FIGS. 7 to 9 have all the features of the energy storage cell 10 from FIG. 1.

A further energy storage cell 10 shown in FIG. 10 differs from the energy storage cell 10 from FIG. 1 in that the surface 18 of the energy storage cell 10 is not the cell housing wall, but a surface of the separator 50. Accordingly, the electrode assembly 16 is divided into two sections which, on the outside, are each (transversely) supported directly on the inner surface of the cell housing 12. On the inside, the support element 20 is clamped between the first and the second section of the electrode assembly 16. Accordingly, the central longitudinal plane of the prismatic cell extends through the support element 20. Furthermore, the energy storage cell 10 from FIG. 10 has all the features of the energy storage cell 10 from FIG. 1. In addition, the energy storage cell 10 from FIG. 10 may have any desired features of the energy storage cells 10 from FIGS. 5 to 9.

The energy storage cell 10 from FIG. 12 differs from the energy storage cell 10 from FIG. 1 (and FIG. 11) in that the energy storage cell 10 from FIG. 12 is in the form of a cylindrical cell. The cylindrical shape of this energy storage cell defines the geometry of the electrode assembly 16 and the support element 20. Accordingly, the support element 20 here is in the form of a hollow-cylindrical body. The surface 18 of the energy storage cell 10 is the (preferably entire) inner circumferential face of the cell housing 12, which means that the support element 20 is clamped between an outer circumferential face of the electrode assembly 16 and the inner circumferential face of the cell housing 12. If the energy storage cell 10 is in the form of a prismatic cell and the electrode assembly 16 is wound (so-called jelly roll), the support element 20 may likewise be in the form of a substantially hollow-cylindrical body and be in contact with the outer circumferential face of the electrode assembly 16. Furthermore, the energy storage cell 10 from FIG. 12 has all the features of the energy storage cell 10 from FIG. 1. In addition, the energy storage cell 10 from FIG. 12 may likewise have any desired features of the energy storage cell 10 from FIGS. 5 to 9.

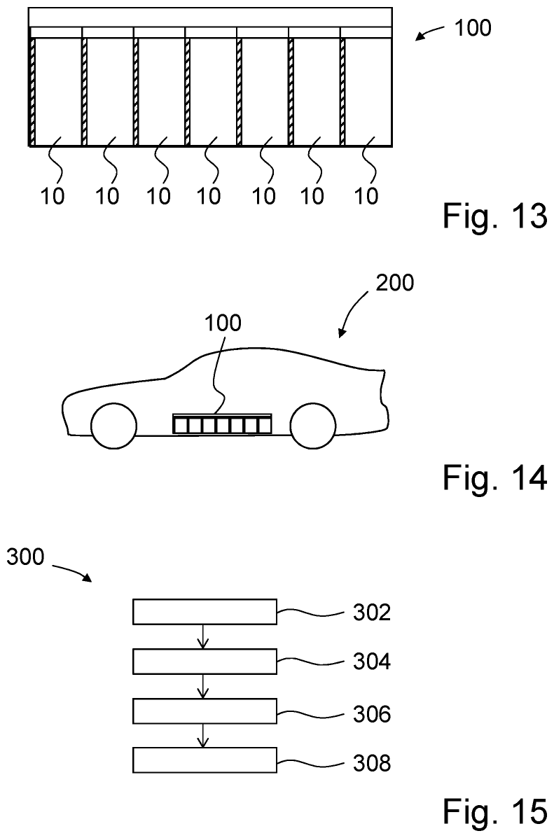

An energy store 100 shown in greatly simplified form in FIG. 13 comprises multiple energy storage cells 10 according to any of FIGS. 1 to 12. The energy storage cells 10, in particular the support elements 20, may be aligned parallel to one another. Furthermore, the energy storage cells 10 may be combined into multiple groups of energy storage cells, each group forming one storage module. In the motor vehicle 200 shown in simplified form in FIG. 14, the energy store 100 may be mounted in the underfloor area between a front axle and a rear axle of the motor vehicle 200.

The energy storage cell 10 may be produced by a method 300 shown in simplified form in FIG. 15. The method comprises, first of all, a first step 302 of providing the cell housing 12. This is followed by a step 304 of disposing the electrode assembly 16 in the inner region of the energy storage cell 10 and a step 306 of disposing the support element 20 in the inner region of the energy storage cell 10. The electrode assembly 16 and the support element 20 may be introduced into the cell housing 12 together or one after the other (in any order). Step 306 may thus alternatively be at least partially carried out before step 304. Preferably, the support element 20 and the electrode assembly 16 are jointly shorter in the direction R than the inner region 14, so that they fit into the latter without being under tension. In the further step 308, the energy storage cell 10 is formed. Here, the electrode assembly 16 may (slightly) expand in the direction R without releasing a fill material 24 held by the support element 20. Advantageously, the support element 20 remains in the initial state. The support element 20 thus provides a further synergetic ancillary function by facilitating the fitting of the electrode assembly 16. Therefore, not only can the energy storage cell 10 be produced efficiently, but the energy storage cell 10 can also be operated efficiently for a longer period of time. After the forming, the support element 20 need not be removed again. Any subsequent opening of the energy storage cell 10 and any sliding of the electrodes can thus be avoided.

For the sake of readability, the expression “at least one” is sometimes omitted in this disclosure for simplification. Where a feature is described in the singular or in the indefinite form (for example, the/a support element, et cetera), the description also includes the disclosure of its plural at the same time (for example, the at least one support element, in other words, the one support element or the multiple support elements). Here, “at least sectionally/partially” means “sectionally/partially or completely”. The term “substantially” in the context of the present disclosure includes, in each case, the exact property or exact value and, in each case, immaterial deviations with respect to the function of the property/value, for example deviations due to manufacturing tolerances.

The preceding description of the present invention serves only for illustrative purpose and does not serve to restrict the invention. In the context of the invention, various alterations and modifications are possible without departing from the scope of the invention and the equivalents thereof.

1-12. (canceled)

13. An energy storage cell, comprising:
a cell housing defining an inner region of the energy storage cell;
an electrode assembly disposed in the inner region together with an electrolyte; and
a support element disposed between a surface of the energy storage cell and at least one part of the electrode assembly, the support element contacting the surface and the at least one part of the electrode assembly;
wherein the support element has a carrier part, and fill material held by the carrier part; and
wherein the support element is configured to at least partially release the fill material to the electrolyte and to decrease in size in a direction transverse to the surface.

14. The energy storage cell according to claim 13, wherein the support element is clamped between the surface of the energy storage cell and the at least one part of the electrode assembly.

15. The energy storage cell according to claim 13, wherein the carrier part has at least one shell that delimits an interior, and the fill material is at least partially contained in the interior.

16. The energy storage cell according to claim 15, wherein the at least one shell is in the form of an elastic membrane.

17. The energy storage cell according to claim 15, wherein the at least one shell is configured to open as a result of expansion of the electrode assembly in the direction transverse to the surface.

18. The energy storage cell according to claim 15, wherein the support element is configured to at least partially release the fill material to the electrolyte through the at least one shell or upon opening of the at least one shell.

19. The energy storage cell according to claim 15, wherein the interior is divided into at least a first chamber and a second chamber, and the fill material is at least partially contained in the first chamber and/or the second chamber.

20. The energy storage cell according to claim 13, wherein the carrier part is porous at least sectionally.

21. The energy storage cell according to claim 13, wherein the fill material is at least partially intercalated in pores of the carrier part.

22. The energy storage cell according to claim 13, wherein the carrier part is fiber-reinforced.

23. The energy storage cell according to claim 13, wherein the carrier part is in the form of a woven textile or in the form of a nonwoven textile, at least sectionally.

24. The energy storage cell according to claim 13, wherein the fill material is at least partially soluble in the electrolyte and/or the fill material comprises a liquid or solid electrolyte additive, a lithium supporting electrolyte, a scavenger, and/or a reaction suppressor.

25. The energy storage cell according to claim 13, wherein the surface of the energy storage cell is an inner face of the cell housing or a surface of a separator of the electrode assembly.

26. The energy storage cell according to claim 13, wherein the surface of the energy storage cell is in planar contact with a side of the support element that is opposite the part of the electrode assembly.

27. The energy storage cell according to claim 13, wherein the cell housing is rigid.

28. The energy storage cell according to claim 13, which is a prismatic cell or a cylindrical cell.

29. The energy storage cell according to claim 13, wherein an anode material of the electrode assembly contains silicon.

30. An energy store comprising at least one energy storage cell according to claim 13.

31. A motor vehicle comprising an energy storage cell according to claim or an energy store comprising the energy storage cell.

32. A method for producing the energy storage cell according to claim 13, comprising:
providing the cell housing defining the inner region;
disposing the electrode assembly in the inner region; and
disposing the support element between the surface of the energy storage cell and the at least one part of the electrode assembly such that the support element is in contact with the surface and the at least one part of the electrode assembly to form the energy storage cell.
